(19) United States
(12) Patent Application Publication
(10) Pub. No.: US 2019/0243566 A1
(43) Pub. Date: Aug. 8, 2019

(54) MEMORY CONTROLLER, MEMORY SYSTEM, AND METHOD OF USING A MEMORY DEVICE

(71) Applicant: Infineon Technologies AG, Neubiberg (DE)

(72) Inventors: Muhammad HASSAN, Munich (DE); Christian MUELLER, Kuenzell (DE); Thomas KERN, Aschheim (DE)

(21) Appl. No.: 15/888,121

(22) Filed: Feb. 5, 2018

(51) Int. Cl. G06F 3/06; G06F 11/10

(52) U.S. Cl. CPC G06F 3/0631; G06F 11/1076; G06F 3/0673; G06F 3/0604

(57) ABSTRACT

In various embodiments, a memory controller is provided. The memory controller may be configured to store data to a first memory portion of a memory, and to store at least one of error detection data or error correction data to be stored to a second memory portion of the memory, wherein the at least one of error detection data or the error correction data are associated with the data, and wherein the memory controller comprises a memory size assigning circuit configured to flexibly assign a size of the second memory portion.

### TECHNICAL FIELD

Various embodiments relate generally to a memory controller and to a method of using a memory device.

### BACKGROUND

Sources of DRAM (memory) errors can be classified into “soft errors” and “hard fails”. A cause for hard fails may be one or more defective memory cells or a defective circuitry of the data path. Soft errors may have various causes, for example a so-called “row hammer”, which may occur in higher density memory arrays and may alter a content of neighboring memory rows that were not addressed in the original memory access. Also alpha particles or cosmic radiation and/or errors during data transmission from and to the memory device may cause soft errors.

Errors in critical data, e.g. in program code, may cause a system fail. Thus, for safety critical applications, data integrity is one of the requirements to reach certain safety and reliability goals.

### SUMMARY

In various embodiments, a memory controller is provided. The memory controller may be configured to store data to a first memory portion of a memory, and to store at least one of error detection data or error correction data to be stored to a second memory portion of the memory, wherein the at least one of error detection data or the error correction data are associated with the data, the memory controller including a memory size assigning circuit configured to flexibly assign a size of the second memory portion.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic representation of a memory system according to a state of the art;

FIG. 2 shows a schematic representation of a memory system according to various embodiments;

FIG. 3 shows schematic visualization of data stored in accordance with different reliability/safety concepts according to various embodiments; and

FIG. 4 shows a flow diagram of a method of using a memory device in accordance with various embodiments.

### DESCRIPTION

The following detailed description refers to the accompanying drawings that show, by way of illustration, specific details and embodiments in which the invention may be practiced.

Various aspects of the disclosure are provided for devices, and various aspects of the disclosure are provided for methods. It will be understood that basic properties of the devices also hold for the methods and vice versa. Therefore, for sake of brevity, duplicate description of such properties may have been omitted.

The word “exemplary” is used herein to mean “serving as an example, instance, or illustration”. Any embodiment or design described herein as “exemplary” is not necessarily to be construed as preferred or advantageous over other embodiments or designs.

In the following, the term “ECC” is used as an abbreviation for “EDC and/or ECC”, unless both are mentioned/differentiated, or it is clear from the context that only one of the two is referred to.

EDC (error detecting code) along with ECC (error correcting code) capability is used for detecting and correcting failing bits. Famous among them is a so-called SECDED (single error correction, double error detection) using a Hamming code that uses 8 bits of ECC for 64 bits of data.

Other codes (e.g. other types and/or higher/lower detection/correction capabilities) can be employed depending upon the targeted safety and reliability goals, e.g. a block ECC, a hierarchical ECC (detection on lower level and correction on higher level of hierarchy, and/or a combination of the data ECC along with an address ECC.

A SECDED code requires a 72 bit wide data bus for 64 bits of user data. Since relevant components (e.g., DRAM components) for servers are usually based on x4 or x8 data lines, extra component(s) are added for storing the ECC data. Adding ECC lines in parallel by increasing the data bus width is called “side band ECC”, since the ECC data are transferred at the same time as the user data.

In mobile applications, memory components (e.g. LPDDR4) are based on higher data bus widths, x16 or x32. Using side band ECC for a x16 data bus would require 6 extra data lines, while for a x32 data bus, it would require 7 extra data lines. Adding extra x16 components for just 6 or 7 check-bits would waste more than 50% of the additional memory space, and also increase an overall system power consumption. Reducing the user data to e.g. 26 bits, allowing to have 6 check bits, would create data transfers with data widths not to the power of 2, which is not desired.

To overcome the issue with fixed data bus widths in certain memory applications, e.g. for LPDDR3/4, where memory components of x4 or x8 are not available, a method called “inline-ECC” has recently been introduced as a replacement for sideband ECC.

In the inline ECC approach, check-bits are transferred on the same data lines, but at a later point in time, as compared to the associated data, e.g. after 64 bits of user data, 8 check bits may be transferred.

In the inline ECC approach, check bits may be stored in the same memory component as the user data, e.g. in dedicated rows, columns, or banks.

Of course, the inline ECC will have a significant impact on a data throughput. At present, optimization schemes regarding the inline ECC approach mostly focus on the throughput. It is for example desired to have just as few regions as required ECC protected, while non-critical data may be stored in regions not having ECC protection (and thus no necessity to have ECC data transferred). This is referred to as the region based ECC concept, which has been introduced to mitigate the impact that the inline ECC has on the data throughput.

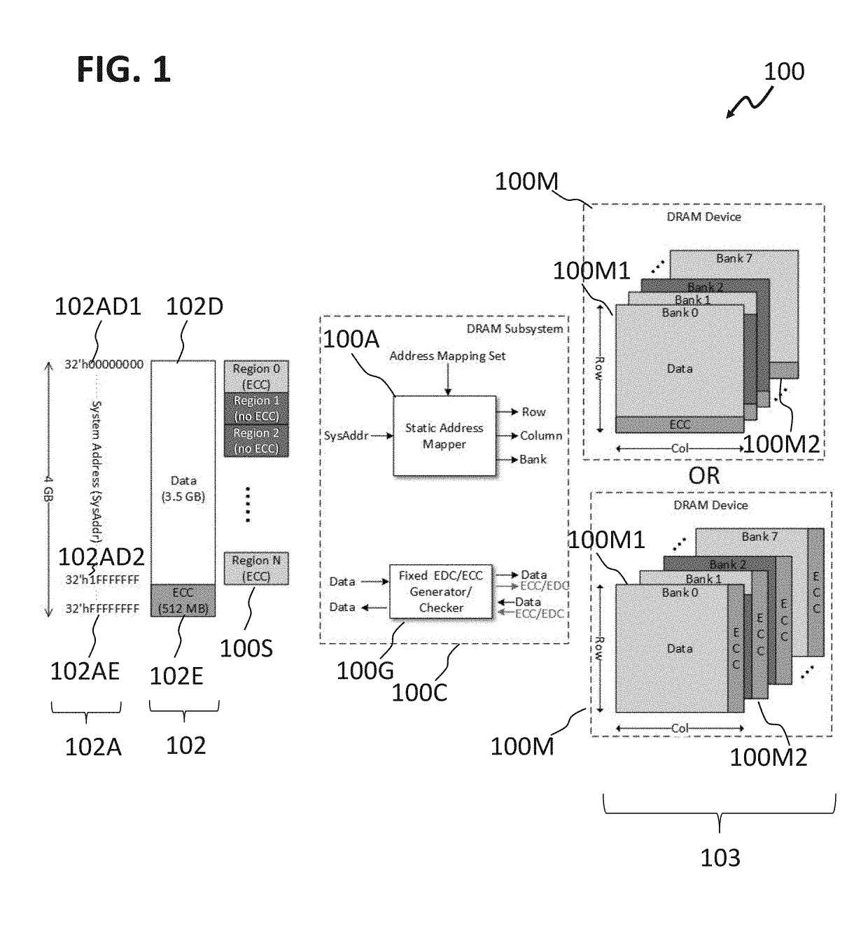

FIG. 1 shows an exemplary memory system 100 of the state of the art using the region based ECC concept, which may include a memory controller 100C and a memory device 103 including at least one memory 100M. For the storing of data 102, which may include the data themselves 102D, and may or may not include ECC/EDC information 102E, the concept may allow the user to configure each region into one of two types: protected or non-protected (the configuration may be done using the selector 100S, for selecting between “ECC” and “no ECC”). Only for the protected memory regions, check bits (the ECC/EDC information 102E) are transferred to (and from) the memory (in other words, the data transfer of the ECC/EDC between a memory controller 100C and the memory itself (the memory cells) 100M may be optional).

Only one fixed type of ECC scheme is typically used (e.g. 64 bits of data and 8 bits for check bits, for single error correction and dual error detection). A size of the region(s) 100M2 used for storing the ECC check bits is also fixed, and does not take any benefit from the presence of non-protected regions. A complete system address space may be divided into two main portions, one portion 100M1 for the data and the second portion 100M2 (⅛th the size of 100M1 for the above described fixed scheme) for the ECC. Within a data storage space portion, several regions may be defined configurable as “ECC protection on” (in FIG. 1, for example Region 0 and Region N) or “ECC protection off” (e.g. Region 1 and Region 2). An address mapper 100A may convert the system addresses 102A to memory (e.g. DRAM-) addresses (row, column, and bank address). The address mapper 100A is typically implemented as a static address mapper with a fixed one-to-one mapping between the system address and the memory (e.g. DRAM-) address. In other words, as shown in FIG. 1, in the state of the art memory system 100, for the system address 102A, all three points for addressing the data 102 may be fixed (in a relative sense): the starting address 102AD1 at which the data 102 start (with the data themselves 102D), the address 102AD2 at which the data themselves 102D end (with the ECC/EDC system address starting thereafter), and the end address 102AE at which the ECC/EDC information ends.

A memory controller 100C within the memory (e.g. DRAM) subsystem may use the memory (e.g. DRAM) addresses to schedule data transactions, and (for ECC enabled regions) ECC transactions, towards devices external to the memory (e.g. DRAM) device. As described above, the physical location of the ECC is configured to either occupy ⅛th portion of either a total of the rows (the alternative shown at the top right of FIG. 1) or of a total of the columns (the alternative shown at the bottom right of FIG. 1) of the memory 100M, within the same or in a different bank.

The region based ECC concept is lacking the capability to assign to each region independently one of various safety levels and reliability grades, utilizing designated EDCs and ECCs schemes for each region.

Furthermore, the approach has a disadvantage in that—in the above example—⅛th (or 12.5%) of the total memory is reserved for storing the optional ECC, and thus not available for a storage of other data, irrespective of how many ECC protected regions are defined.

In various embodiments, a method is described how the region based ECC approach described above in context with FIG. 1 may be extended to define independent safety and reliability levels for each region using designated EDCs and/or ECCs.

The size of the region used for storing ECC check bits may have a direct relationship to a kind of EDC and/or ECC schemes being used.

In other words, when storing data using a memory system in accordance with various embodiments, a data safety scheme may be defined, e.g. by the user, and an amount of storage space (and respective address) for the corresponding ECC (if required) may flexibly be assigned in the memory device.

As yet another way to phrase it, the region based approach may be extended to support flexible assignment of data regions to various reliability grades or safety levels utilizing designated EDCs and ECCs.

Furthermore, a switching to a higher reliability grade may also be possible during runtime, for example in a case of a user condition (e.g. temperature) changing.

In various embodiments, the memory system may include, e.g. as part of a memory controller, a flexible address mapper and a flexible ECC/EDC generator and checker. The flexible address mapper may be configured to generate a memory address (e.g. a DRAM memory address) based on a region that is targeted by a transaction, and what kind of EDC/ECC scheme is employed for that region. The flexible ECC/EDC generator and checker may be configured to work in accordance with a plurality of appropriate methods defined for each region, instead of working in accordance with on only one method/scheme. In other words, instead of relying totally on one EDC/ECC scheme like, e.g., a Hamming code, a more advanced scheme, e.g. a Block ECC, an hierarchical ECC (detection on lower level and correction on higher level of the hierarchy) and/or an EDC/ECC that uses a combination of the data ECC along with address ECC, may be employed for the region(s) where higher reliability is required or desired.

The methods/schemes and their assignment to various regions may in various embodiments be configured by a manufacturer of the memory system (or of the memory controller, respectively). In other embodiments, the methods/schemes may be configured by a user.

The flexible address mapper and flexible ECC/EDC generator and checker may work irrespective of whereto in the memory the ECC/EDC portion is stored, e.g. fixed columns or fixed rows within the same bank, or in different banks.

The total memory portion allocated to ECC/EDC may thus not remain constant to be ⅛th of the total memory. Instead, the total memory portion allocated to ECC/EDC may be directly related to the number of regions and their assigned reliability grade and safety level.

If a storing of ECC/EDC information is not required or not desired for a given region, no space will be reserved for that region for the storing of ECC/EDC information.

In various embodiments, a memory controller allowing a more efficient data storage scheme, and a corresponding memory system, may be provided. For example, in a case of at least a portion of the data not requiring the ECC/EDC information, more space may be made available for storage of regular data.

In various embodiments, in a case of a portion of the data requiring a higher level of availability and/or safety, a larger-than-average portion of the total storage space may be dedicated to the ECC/EDC information of one region or several regions, whereas in the remaining regions (which may require a lower level of availability and/or safety), the portion of the total storage space dedicated to the respective ECC/EDC information may be lower or even zero.

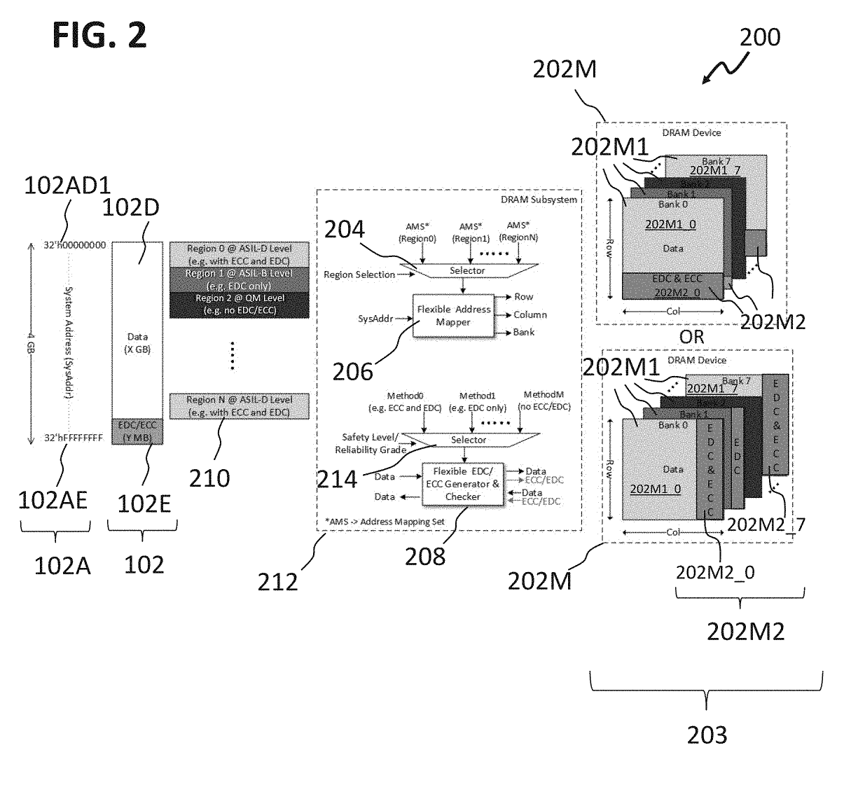

FIG. 2 shows a schematic representation of a memory system 200 according to various embodiments, which may include a memory controller 212 and a memory device 203. It shows a flexible assignment of data regions (Region 0 to Region N) from a system perspective. The memory system 200 may for example include a DRAM device 203, or a different type of random access memory device, e.g. a non-volatile random access memory device, having a memory 202M including a first memory portion 202M1 and a second memory portion 202M2.

In the memory system 200, a number of regions to be formed/assigned in the memory 202M and a size of each of the regions may be user configurable using a memory size assigning circuit 210. In various embodiments, the memory size assigning circuit 210 may be part of the memory controller 212. In other embodiments, it may be an individual circuit interacting with the memory controller 212.

Using the memory size assigning circuit 210, a user may define the number of regions (e.g., Region 0 to Region N), for example by specifying N. The user may further define, using the memory size assigning circuit 210, an individual reliability grade and safety level, also referred to as data integrity scheme, integrity scheme or scheme for short, for each of the regions. In that case, the memory controller 212, e.g. an EDC/ECC method selecting circuit 214, also referred to as the EDC/ECC method selector 214, which may be integrated in the memory controller 212, may be configured to provide an appropriate EDC/ECC method corresponding to the selected integrity scheme to a generating/checking circuit 208, also referred to as EDC/ECC generator and checker 208 (to be described below). In various embodiments, instead of or in addition to specifying the individual reliability grade and safety level (i.e., the integrity scheme), the user may directly specify the EDC/ECC method, which may be directly or indirectly provided to the EDC/ECC generator and checker 208.

Depending on the EDC/ECC method selected for each of the regions, i.e., whenever a certain error detection and/or error correction capability is to be provided, it may be required to store at least one of error detection data or error correction data 102E (also referred to as EDC/ECC data 102E), which may be associated with the data, in the memory 202M. The memory controller 212 may be configured to store the data 102D to the first memory portion 200M1, and to store at least one of error detection data or error correction data to be stored (the EDC/ECC data) 102E to the second memory portion 200M2, wherein the EDC/ECC data 102E are associated with the data 102D. In a case that no error detection and/or error correction capability is to be provided, no error detection and/or error correction data 102E need to be stored. The memory controller 212 may be configured to not store the EDC/ECC data 102E in that case. The memory controller 212 may further be configured not to store the EDC/ECC data 102E outside the second memory portion 200M2.

The memory size assigning circuit 210 may be configured to flexibly assign a size of the second memory portion 202M2. The size to be assigned to the second memory portion 202M2 may depend on the data integrity scheme(s), and thus on the corresponding EDC/ECC method(s). The size to be assigned may be sufficiently large for storing the EDC/ECC data 102E.

Each of the defined regions may be mapped to the memory 202M by a memory address determination circuit 206, also referred to as flexible address mapper 206. The memory address determination circuit 206 may be configured to assign a first memory address to a data portion of the data 102D to be stored in the first memory portion 202M1, and a second memory address to at least one of an error detection data portion or an error correction data portion of the at least one of error detection data or error correction data 102E to be stored in the second memory portion 202M2.

In the exemplary embodiment shown in FIG. 2, the memory 202M may be addressed by row, column and bank. In other words, a plurality of addresses assignable by the memory address determination circuit 206 may form a cube-like address space defined by a column forming a first dimension of the cube, a row forming a second dimension of the cube, and a bank forming a third dimension of the cube. In the example, each of the regions 0 to N (in the example, N may be 7) may be mapped to one of the banks of the memory 202M.

The first memory address and the second memory address may for example be organized in such a way that, in every bank, the first memory portion 202M1 and the second memory portion 202M2 occupy different rows (as shown in the top configuration of the two alternative memory configurations shown in FIG. 2). Alternatively, as shown in the bottom configuration in FIG. 2, in every bank, the first memory portion 202M1 and the second memory portion 202M2 occupy different rows. Yet another alternative may use a more complex mapping scheme, e.g. having a given region mapped to multiple banks instead of just one bank, or the like.

In various embodiments, an input to the memory address determination circuit 206 may be provided by a first selection circuit 204, also referred to as main selector 203, which may be configured to switch between various address mapping sets AMS. The switching may be done based on the region of the specified regions in which a system address (SysAddr) of a coming transaction lies. In other words, the switching and the address mapping set used may depend on a selected region provided by the memory size assigning circuit 210. Thus, in various embodiments, by specifying a system address that lies in one of the predefined regions, with its associated data integrity scheme, a size of the corresponding portion of the second memory portion 202M2 required for storing the EDC/ECC data 102E may be defined. Thereby, also a size of the corresponding portion of the first memory portion 202M1 available for storing the data 102D may be defined as a difference between the size of the total memory portion available for the specified region and the size of the second memory portion 202M2. In other words, the size of the region may have a predefined value, and by defining a size of the second memory portion 202M2, the size of the first memory portion 202M1 may be defined as well. In various embodiments, the sum of the size of the first memory portion 200M1 and the size of the second memory portion 200M2 may be a predefined constant value region-wise, e.g. all regions may be defined to have the same total size.

The address mapping set AMS may be dedicated to each region individually, or multiple regions with the same reliability grade and safety level may be mapped using the same address mapping set. Using the address mapping set AMS provided by the first selection circuit 204, the memory address determination circuit 206 may be configured to provide the memory address in terms of, e.g., row, column and bank. In other words, the flexible address mapper 206 may work on the selected address mapping set AMS to convert the system address of the transaction to appropriate row, column and bank address for the data 102D and the EDC/ECC data 102E.

In the example shown in FIG. 2, using the memory size assigning circuit 210, the individual reliability grade and safety level for each of the regions may be provided as one of a plurality of Automotive Safety Integrity Levels as known in the art. The ASIL range from ASIL D, representing the highest degree of automotive hazard and highest degree of rigor applied in the assurance the resultant safety requirements, to QM, representing application with no automotive hazards. The intervening levels ASIL C to ASIL A are simply a range of intermediate degrees of hazard and degrees of assurance required.

As shown in FIG. 2, for each of Region 0 and Region N, an ASIL-D level is specified, which may represent the highest requirements on data integrity, such that for the data 102D of Region 0 and Region N, both ECC and EDC scheme may be used. As a a consequence of selecting Region 0 or Region N for an upcoming transaction, i.e. a data storage request, the address mapping set AMS to be used by the memory address determination circuit 206 may be switched by the first selection circuit to the address mapping set AMS that specifies the (relatively) large allocation of memory space required for storing the EDC/ECC data 102E. The flexible address mapper 206 may be configured to use the AMS for converting the system address to the memory address in such a way that the address for the EDC/ECC data 102E corresponds to (a portion of) the second memory region 202M2_0 or 202M2_7, respectively. Furthermore, the flexible address mapper 206 may be configured to use the AMS for converting the system address to the memory address in such a way that the address for the data 102D (to which the EDC/ECC data 102E correspond) may correspond to (a portion of) the first memory region 202M1_0 or 202M1_7, respectively.

Similarly, as shown in FIG. 2, for Region 1, an ASIL-B level is specified, which may represent more moderate requirements on data integrity than ASIL-D, such that for the data 102D of Region 1, just using an EDC scheme may be sufficient. As a a consequence of selecting Region 1 for an upcoming transaction, i.e. a data storage request, the address mapping set AMS to be used by the memory address determination circuit 206 may be switched by the first selection circuit to the address mapping set AMS that specifies an only moderately large allocation of memory space required for storing the EDC data 102E. The flexible address mapper 206 may be configured to use the ANIS for converting the system address to the memory address in such a way that the address for the EDC data 102E corresponds to (a portion of) the second memory region 202M2_1 (not labelled in FIG. 2 for reasons of legibility). Furthermore, the flexible address mapper 206 may be configured to use the ANIS for converting the system address to the memory address in such a way that the address for the data 102D (to which the EDC data 102E correspond) may correspond to (a portion of) the first memory region 202M1_1 (not labelled in FIG. 2 for reasons of legibility), respectively.

As shown in FIG. 2, for Region 2, a QM-(Quality Management-)level is specified, which may not place any constraints on data integrity, i.e. data reliability is not essential. Therefore, no EDC/ECC data 102E may be stored. In accordance with this, the address mapping set AMS may specify that not memory space needs to be allocated for the EDC/ECC data 102E. As a consequence, the flexible address mapper 206 may be configured to use the AMS for converting the system address to the memory address in such a way that a whole of the (portion of the) first memory region 202M1_2 is available for the storage of the data 102D.

In various embodiments, as described above, the memory controller 212 may include the EDC/ECC method selector 214, which may be configured to provide an appropriate EDC/ECC method corresponding to the selected integrity scheme, and the EDC/ECC generator and checker 208, to which the appropriate EDC/ECC method may be provided.

The EDC/ECC generator and checker 208 may be configured to receive the data 102D and the EDC/ECC method and to generate, in accordance with the selected reliability grade and safety level, if applicable, corresponding EDC/ECC data 102E. The EDC/ECC generator and checker 208 may further be configured to not generate such EDC/ECC data 102E if the selected reliability grade and safety level is defined to not provide EDC/ECC data 102E, as shown for example for Region 2 in FIG. 2.

A calculation method for generating the EDC/ECC data 102, i.e. the EDC/ECC method, may not be limited to a Hamming code of 64:8 (data:checkbits), but may apply a more advanced scheme like, e.g., a block ECC, an hierarchical ECC, and/or other codes as known in the art.

In various embodiments, for writing data to the memory 202M, e.g. the DRAM, the flexible EDC/ECC generator 208 within the memory (e.g. DRAM) subsystem may use the appropriate method (as selected/provided by the EDC/ECC method selector 214) to generate the associate EDC/ECC 102E.

In various embodiments, for reading data from the memory, e.g. DRAM, the flexible EDC/ECC checker 208 within the memory (e.g., DRAM-) subsystem will compare the EDC/ECC data received from the memory 202M (e.g., the DRAM) with the reference calculated according to the appropriate method for that region.

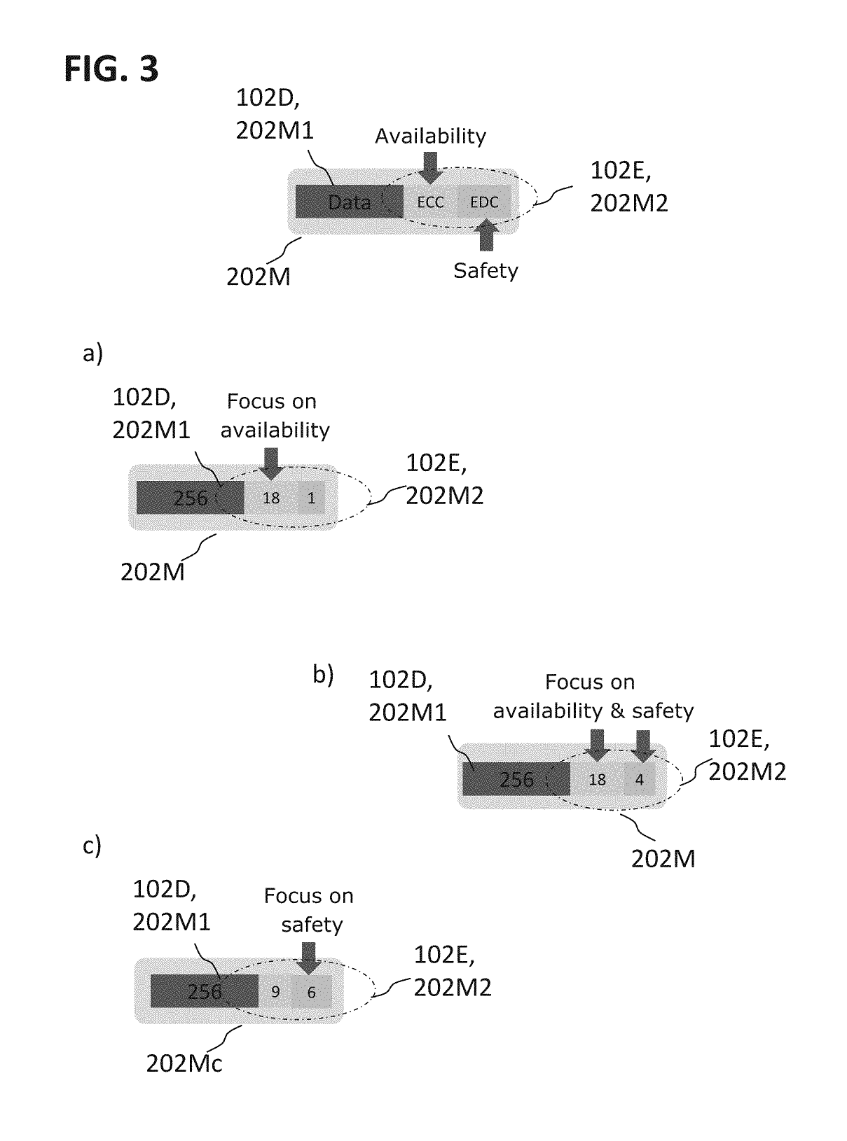

FIG. 3 shows examples of how different reliability and safety requirements for the data 102D (e.g., various safety grades) may vary the size of ECC/EDC, such that a flexibility in the ECC/EDC generator and checker 208 may be required to select the appropriate method for that region for efficiently using the available memory space.

In all of the examples a), b) and c) shown in FIG. 3, an error detection/correction is performed on 256 bit of data 102D.

If a bit error rate is fairly low, a low-level data integrity scheme may be applied, for example an ECC/EDC allowing for 1 bit error correction and 2 bit error detection, also referred to as 1 bit ECC/2 bit EDC or, as described above, SECDED. This may be sufficient for the low memory failure rate. The SECDED for the 256 bits of data 102D may require 9 bits of ECC/EDC data 102E for the single error correction (SEC), and another single bit for the double error detection (DED). A resulting multi-bit error detection coverage (in other words, a probability of detecting a multi-bit-error) may be computed as:

SECDED: 256+9+1−>PD_{MB}=1−(1+266)/2¹⁰˜74.9%

For high availability (lower ASIL grade), a so-called DECTED data integrity scheme may be used.

DECTED may include a 2-bit error correction (“double error correction”, DEC) on 256 bit, which may require additional 9 bits of ECC/EDC data 102E as compared to the SEC.

Overhead to 256 bits is (without the triple error detection TED): 18/256˜7%. In other words, for DEC-protecting the 256 bits of data 102D, the size of the memory region dedicated to the ECC/EDC data 102E needs to be about 7% of the size of the data 102D.

The “triple bit error detection” (TED) without a “multibit error detection coverage of greater than 99%” requires 1 extra bit. This case is shown in panel a) of FIG. 3. Here, a focus may be on availability, in other words, on keeping a related system running by correcting most errors.

As a consequence, the overhead (DEC+TED) is 19/256˜7.4%.

The resulting multibit error detection coverage PD_{MB} is

PD_{MB}=1−(1+275+275*274/2)/2¹⁹˜92.7%

An ASIL-D region requires high multibit error detection coverage due to the highest safety grade (PD_{MB}>99%).

To achieve this, an addition of another extra 3 checkbits yields:

PD_{MB}=1−(1+278+278*277/2)/2²²˜99.07>99%

This ASIL-D case is shown in panel b) of FIG. 3. Here, a focus may be on both, availability and safety, in other words, on keeping a related system running by correcting most errors and detecting most errors, too.

For reaching an ASIL-D level from SECDED, 5 extra bits may need to be added. This case is shown in panel c) of FIG. 3. Here, a focus may be on safety, in other words, on detecting an error, even if it means that a system may not be kept in a running state but may have to be switched off or be transferred to another safe mode. The resulting multibit error detection coverage is:

PD_{MB}=141+271)/2¹⁵˜99,2%>99%

By using the concept of mapping the memory into regions, an amount of memory space dedicated to the ECC/EDC data 102E may be adjusted to what is really needed/used, as opposed to the prior art, where the memory space is allocated for the ECC/EDC data 102E, irrespective of whether they are actually generated or not.

Furthermore, different safety levels and reliability grades may be realized in the different regions, such that for each portion of data 102D to be written to the memory 200M, a suitable region may be selected among the provided regions.

For a region with a requirement of high availability along with ASIL-D grade, the data 102D to ECC/EDC 102E ratio may be 256:22 (see description related to FIG. 3, panel b) above).

For a region with a requirement of high availability along with lower ASIL grade (e.g., ASIL-B), the data 102D to ECC/EDC 102E ratio may be 256:19 (see description related to FIG. 3, panel a) above).

For a region with no high availability requirement, along with ASIL-D grade, the data 102D to ECC/EDC 102E ratio may be 256:15 (see description related to FIG. 3, panel c) above).

For a region with no high availability requirement, along with lower ASIL grade (e.g., ASIL-B), the data 102D to ECC/EDC 102E ratio may be 256:10.

For a region with no availability requirement, nor any ASIL level, and which may not be required to use any ECC or EDC (such as a region dedicated to a storage of quality management data), the data 102D to ECC/EDC 102E ratio may be 256:0, since no ECC/EDC 102E data may be stored, and no memory space will be provided for ECC/EDC data 102E.

In various embodiments, the flexible address mapper 206 may be configured to generate appropriate memory (e.g. DRAM-) addresses based on different requirements of the regions and using the separate address mapping sets to efficiently utilize the available capacity of the memory (e.g. DRAM) device 200.

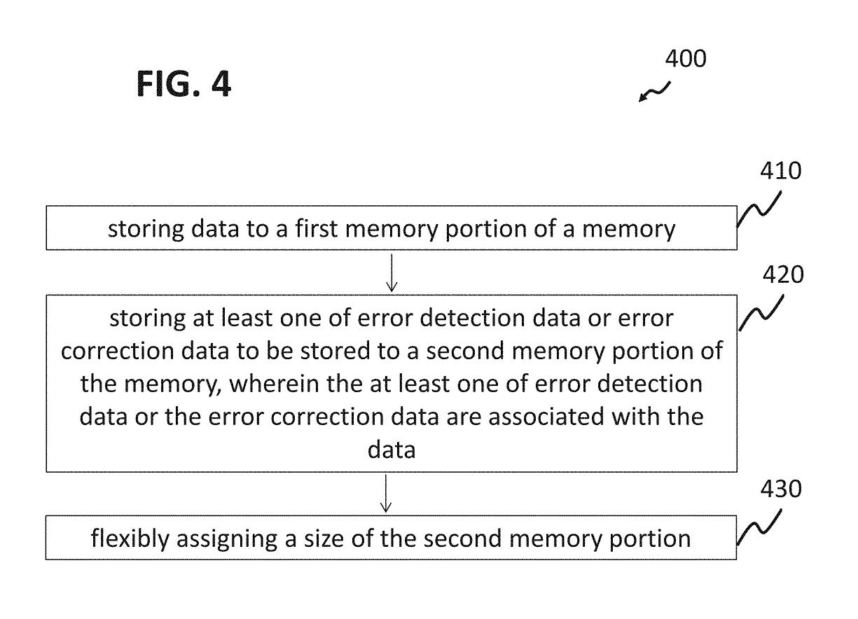

FIG. 4 shows a flow diagram 400 of a method of using a memory device in accordance with various embodiments.

The memory device may include at least one memory having a first memory portion and a second memory portion. The method may include storing data to the first memory portion (in 410), storing at least one of error detection data or error correction data to be stored to the second memory portion, wherein the at least one of error detection data or the error correction data are associated with the data (in 420), and flexibly assigning a size of the second memory portion (in 430).

Various examples will be illustrated in the following:

Example 1 is a memory controller. The memory controller may be configured to store data to a first memory portion of a memory, and to store at least one of error detection data or error correction data to be stored to a second memory portion of the memory, wherein the at least one of error detection data or the error correction data are associated with the data, and the memory controller may include a memory size assigning circuit configured to flexibly assign a size of the second memory portion.

In Example 2, the subject-matter of Example 1 may optionally include a memory address determination circuit configured to assign a first memory address to a data portion of the data to be stored in the first memory portion and a second memory address to at least one of an error detection data portion or an error correction data portion of the at least one of error detection data or error correction data to be stored in the second memory portion;

In Example 3, the subject matter of any one of Examples 1 or 2 may optionally include that the memory controller is further configured not to store the at least one of error detection data or error correction data outside the second memory portion.

In Example 4, the subject matter of any one of Examples 1 to 3 may optionally include that the memory size assigning circuit is further configured to flexibly assign the size of the second memory portion based on at least one of the error detection data or error correction data to be stored to the second memory portion.

In Example 5, the subject matter of any one of Examples 1 to 4 may optionally include that the memory size assigning circuit is further configured to flexibly assign the size of the second memory portion based on a predefined degree of at least one of availability or safety.

In Example 6, the subject matter of Example 4 or 5 may optionally include that the memory size assigning circuit is further configured to flexibly assign the size of the first memory portion based on the size of the second memory portion.

In Example 7, the subject matter of Example 6 may optionally include that the memory size assigning circuit is further configured to flexibly assign a size of the first memory portion such that a sum of the size of the first memory portion and the size of the second memory portion is a predefined constant value.

In Example 8, the subject matter of any one of Examples 1 to 7 may optionally include that the memory includes a random access memory.

In Example 9, the subject matter of Example 8 may optionally include that the random access memory includes a dynamic random access memory.

In Example 10, the subject matter of Example 8 or 9 may optionally include that the random access memory includes a non-volatile random access memory.

In Example 11, the subject matter any one of Examples 1 to 10 may optionally include that a plurality of addresses assignable by the memory address determination circuit form a cube-like address space defined by a column forming a first dimension of the cube, a row forming a second dimension of the cube, and a bank forming a third dimension of the cube.

In Example 12, the subject matter of Example 11 may optionally include that an address assignable to the second memory portion includes at least one predefined row value or at least one predefined column value.

In Example 13, the subject matter of Example 12 may optionally include that an address assignable to the first memory portion includes, in the case of the predefined row value, a different row value than the at least one predefined row value or, in the case of the predefined column value, a different column value than the at least one predefined column value.

Example 14 is a memory system including the memory controller of any of Examples 1 to 13, and a memory device including the memory.

Example 15 is a method of using a memory device, the memory device including at least one memory having a first memory portion and a second memory portion. The method may include storing data to the first memory portion, storing at least one of error detection data or error correction data to be stored to the second memory portion, wherein the at least one of error detection data or the error correction data are associated with the data, and flexibly assigning a size of the second memory portion.

In Example 16, the subject matter of Example 15 may optionally further include assigning a first memory address to a data portion of the data to be stored in the first memory portion and a second memory address to at least one of an error detection data portion or an error correction data portion of the at least one of error detection data or error correction data to be stored in the second memory portion.

In Example 17, the subject matter of Example 15 or 16 may optionally include that the flexibly assigning a size of the second memory portion includes assigning a size of zero to the second memory portion, so that no error detection or error correction data is stored in the second memory portion.

In Example 18, the subject matter of any one of Examples 15 to 17 may optionally include that the flexibly assigning a size of the second memory portion includes flexibly assigning the size of the second memory portion based on at least one of the error detection data or error correction data to be stored to the second memory portion.

In Example 19, the subject matter of any one of Examples 15 to 18 may optionally include that the flexibly assigning a size of the second memory portion includes flexibly assigning the size of the second memory portion based on a predefined degree of at least one of availability or safety.

In Example 20, the subject matter of any one of Examples 15 to 19 may optionally further include flexibly assigning a size of the first memory portion based on the size of the second memory portion.

In Example 21, the subject matter of any one of Examples 15 to 20 may optionally include that the flexibly assigning a size of the first memory portion includes flexibly assigning the size of the first memory portion such that a sum of the size of the first memory portion and the size of the second memory portion is a predefined constant value.

In Example 22, the subject matter of any one of Examples 15 to 21 may optionally include that the memory includes a random access memory.

In Example 23, the subject matter of Example 22 may optionally include that the random access memory includes a dynamic random access memory.

In Example 24, the subject matter of any one of Examples 22 or 23 may optionally include that the random access memory includes a non-volatile random access memory.

In Example 25, the subject matter of any one of Examples 15 to 24 may optionally include that a plurality of addresses assignable by the memory address determination circuit form a cube-like address space defined by a column forming a first dimension of the cube, a row forming a second dimension of the cube, and a bank forming a third dimension of the cube.

In Example 26, the subject matter of Examples 15 to 25 may optionally include that an address assignable to the second memory portion includes at least one predefined row value or at least one predefined column value.

In Example 27, the subject matter of any one of Examples 15 to 26 may optionally include that an address assignable to the first memory portion includes, in the case of the predefined row value, a different row value than the at least one predefined row value or, in the case of the predefined column value, a different column value than the at least one predefined column value.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A memory controller configured to:
store data to a first memory portion of a memory;
store at least one of error detection data or error correction data to be stored to a second memory portion of the memory, wherein the at least one of error detection data or the error correction data are associated with the data;
the memory controller comprising a memory size assigning circuit configured to flexibly assign a size of the second memory portion based on a plurality of error detection data or error correction data schemes used to selectively store the at least one of error detection data or error correction data associated with the data, and an error detection data or error correction data selector configured to select a first error detection data or error correction data scheme of the plurality of error detection data or error correction data schemes to store the at least one of error detection data or error correction data.

2. The memory controller of claim 1,
wherein the memory controller is further configured not to store the at least one of error detection data or error correction data outside the second memory portion.

3. The memory controller of claim 1,
wherein the memory size assigning circuit is further configured to flexibly assign the size of the second memory portion based on at least one of the error detection data or error correction data to be stored to the second memory portion.

4. The memory controller of claim 1,
wherein the memory size assigning circuit is further configured to flexibly assign the size of the second memory portion based on a predefined degree of at least one of availability or safety.

5. The memory controller of claim 3,
wherein the memory size assigning circuit is further configured to flexibly assign the size of the first memory portion based on the size of the second memory portion.

6. The memory controller of claim 5,
wherein the memory size assigning circuit is further configured to flexibly assign a size of the first memory portion such that a sum of the size of the first memory portion and the size of the second memory portion is a predefined constant value.

7. The memory controller of claim 1,
wherein a plurality of addresses assignable by the memory address determination circuit form a cube-like address space defined by a column forming a first dimension of the cube, a row forming a second dimension of the cube, and a bank forming a third dimension of the cube.

8. The memory controller of claim 7,
wherein an address assignable to the second memory portion comprises at least one predefined row value or at least one predefined column value.

9. The memory controller of claim 8,
wherein an address assignable to the first memory portion comprises, in the case of the predefined row value, a different row value than the at least one predefined row value or, in the case of the predefined column value, a different column value than the at least one predefined column value.

10. A memory system comprising:
the memory controller of claim 1; and
a memory device comprising the memory.

11. A method for a memory controller to control data storage in a memory device, the memory device comprising at least one memory comprising a first memory portion and a second memory portion, the method comprising:
storing data to the first memory portion;
storing at least one of error detection data or error correction data to be stored to the second memory portion, wherein the at least one of error detection data or the error correction data are associated with the data; and
flexibly assigning a size of the second memory portion based on a plurality of error detection data and/or error correction data schemes used to selectively store the error detection data or error correction data associated with the data.

12. The method of using a memory device of claim 11, further comprising:
assigning a first memory address to a data portion of the data to be stored in the first memory portion and a second memory address to at least one of an error detection data portion or an error correction data portion of the at least one of error detection data or error correction data to be stored in the second memory portion.

13. The method of using a memory device of claim 11,
wherein the flexibly assigning a size of the second memory portion comprises assigning a size of zero to the second memory portion, so that no error detection or error correction data is stored in the second memory portion.

14. The method of using a memory device of claim 11,
wherein the flexibly assigning a size of the second memory portion comprises flexibly assigning the size of the second memory portion based on at least one of the error detection data or error correction data to be stored to the second memory portion.

15. The method of using a memory device of claim 11,
wherein the flexibly assigning a size of the second memory portion comprises flexibly assigning the size of the second memory portion based on a predefined degree of at least one of availability or safety.

16. The method of using a memory device of claim 11, further comprising:
flexibly assigning a size of the first memory portion based on the size of the second memory portion.

17. The method of using a memory device of claim 11,
wherein the flexibly assigning a size of the first memory portion comprises flexibly assigning the size of the first memory portion such that a sum of the size of the first memory portion and the size of the second memory portion is a predefined constant value.

18. The method of using a memory device of claim 11,
wherein a plurality of addresses assignable by the memory address determination circuit form a cube-like address space defined by a column forming a first dimension of the cube, a row forming a second dimension of the cube, and a bank forming a third dimension of the cube.

19. The method of using a memory device of claim 18,
wherein an address assignable to the second memory portion comprises at least one predefined row value or at least one predefined column value.

20. The method of using a memory device of claim 19,
wherein an address assignable to the first memory portion comprises, in the case of the predefined row value, a different row value than the at least one predefined row value or, in the case of the predefined column value, a different column value than the at least one predefined column value.
